(19) United States
(12) Patent Application Publication
(10) Pub. No.: US 2004/0075228 A1
(43) Pub. Date: Apr. 22, 2004

(54) Method and apparatus for linking an ambulatory IV rack and a medical patient carrier

(76) Inventor: Charles T. Duffey, Roseville, CA (US)

Correspondence Address: Charles T. Duffey, 2920 Tilden Drive, Roseville, CA, 95661, US

(21) Appl. No.: 10/271,498

(22) Filed: Oct. 16, 2002

(51) Int. Cl. B62B 9/00

(52) U.S. Cl. 280/47.38

(57) ABSTRACT

The method and apparatus of the present invention provides a mechanical linkage device for attaching a medical patient transport vehicle to an ambulatory intravenous carrier rack. Since the preferred embodiment of the present invention provides adjustability, the medical transport device can be a bed, a child's wagon, a wheelchair, or any other transport device that has a rigid axel allowing the device to be attached.

### BRIEF DESCRIPTION

The subject of this invention relates to the medical industry. Specifically, this invention concerns an apparatus and method for safely and conveniently attaching an ambulatory intravenous dispenser rack to a patient carrier, particularly, a child patient carrier.

### BACKGROUND OF THE INVENTION

Modern hospitals have a need to transport patients from one area to another, for example, for x-rays or some other specialized treatment. Many times these patients require a continuous input of fluid from an intravenous (IV) bag. Typically, these bags contain blood, saline solutions, or some other fluid required by the patient. In order to move the fluid dispensing system with the patient, many mobile IV racks have been developed and are known in the art.

But these current IV racks have a number of severe limitations. For example, the patient can move the IV dispenser by themselves if they are able. However, if they are not, for example, if the patient is in a bed or is a child unable to navigate the large, cumbersome and poorly balanced IV dispensers of contemporary design, a nurse or some other hospital personnel must manage the task. This is a serious waste of human resources. Further, by their very nature, these IV dispenser racks are easily toppled since the weight of the fluid bag or bags is at the top, creating a top-heavy design. Current practices for eliminating the inefficiency associated with multiple hospital personnel include attaching IV racks to medical transport vehicles with medical tape, bungee cords, and other temporary measures that create a high risk of accidental toppling.

Some IV racks have been in use which can be separated from their trundles and placed in a holder on a bed. This works well enough for adult patients, but where child patients are involved, the patient transport device may be too small to accommodate this arrangement. For example, many hospitals use small wagons to transport child patients. This mode of transport is both functional and adds an element of fun to a child's experience in the hospital.

None of the ambulatory IV racks in current use have the capability to attach to a patient transport device simply and safely. What would be desirable would be a method that allows the ambulatory IV rack to be linked to a variety of patient transport devices simply and safely. The method and apparatus of the present invention provides such a solution as is described in detail below in conjunction with the figures attached.

### SUMMARY OF THE INVENTION

The method and apparatus of the present invention provides a mechanical linkage device for attaching a medical patient transport vehicle to an ambulatory intravenous carrier rack. Since the preferred embodiment of the present invention provides adjustability, the medical transport device can be a bed, a child's wagon, a wheelchair, or any other transport device that has a rigid axel allowing the device to be attached.

One end of a rigid linkage member engages the axel of the medical transport device in such a way as to prevent slippage. The other end of the rigid linkage member attaches to the ambulatory IV dispenser rack. In its operative position the apparatus of the present invention pulls the ambulatory IV dispenser rack from the bottom, creating a low center of pull. One person may now move the patient transport device and the associated IV dispenser safely and without assistance.

One advantage of a preferred embodiment of the present invention is that it is adjustable such that a single apparatus may be used for a plurality of medical transport vehicles. Other advantages and features of the present invention are discussed in conjunction with the figures below.

### BRIEF DESCRIPTION OF THE DRAWINGS

FIG. 1: is an overview of the IV link apparatus of one embodiment of the present invention in use.

FIG. 2: is a detailed view of one embodiment of the inventive apparatus disclosed herein.

FIG. 3: is a detailed view of the preferred embodiment of the inventive apparatus disclosed herein.

### DETAILED DESCRIPTION OF PREFERRED EMBODIMENTS

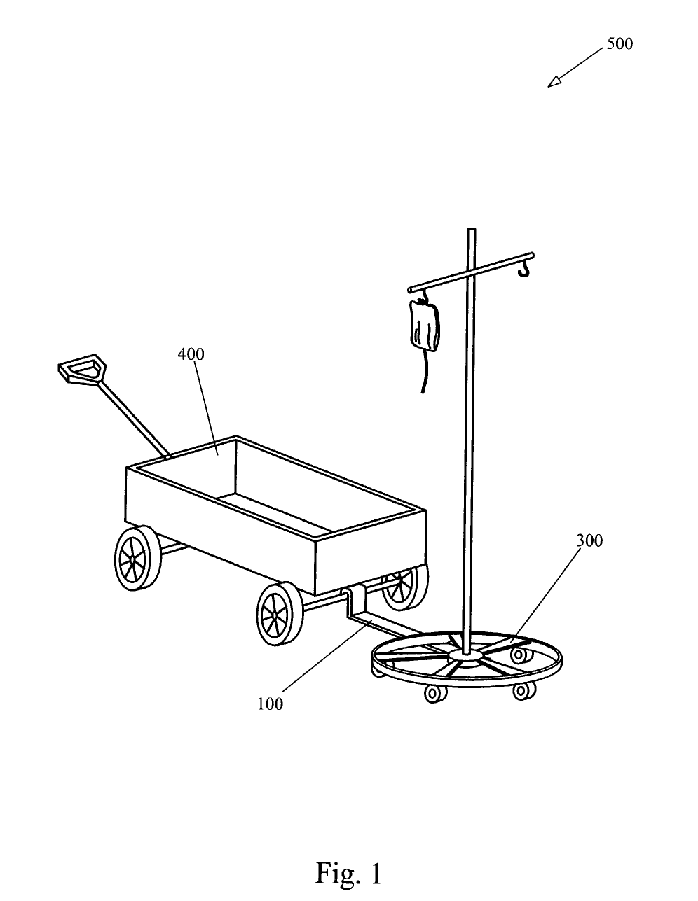

As described briefly above, the present invention allows a mobile IV rack, for example, those used in the medical industry to be safely attached to a medical transport vehicle such that a single person can move both the vehicle and the IV rack together. FIG. 1 shows an overview 500 of one embodiment of the present invention in use. A medical transport vehicle 400, in this instance is a child's wagon, is shown. Hospitals use transports such as the child's wagon for economy, safety, and to provide a small element of fun for invalid children. Although the medical transport vehicle 400 shown in FIG. 1 is a wagon, it will be obvious that other vehicles, for example a wheel chair or a gurney, could be used without departing from the sprit of the present invention, thus the invention is limited only by the claims.

Also shown in FIG. 1 is a typical mobile IV rack 300. In this example the IV rack 300 is of the multi-wheeled type with a single “T” bar for hanging IV bags and/or other medically required paraphernalia, however, it will be recognized that other types of IV racks could be used without departing from the method of the present invention. Mobile IV rack 300 is linked to the medical transport vehicle 400 by rigid link member 100. As will be described in detail below, rigid link member 100 may have many variations without departing from the spirit of the present invention. In this embodiment of the present invention, the rigid link member 100 has no adjustable elements, thus is made for use with a specific type of medical transport vehicle 400 and IV rack 300.

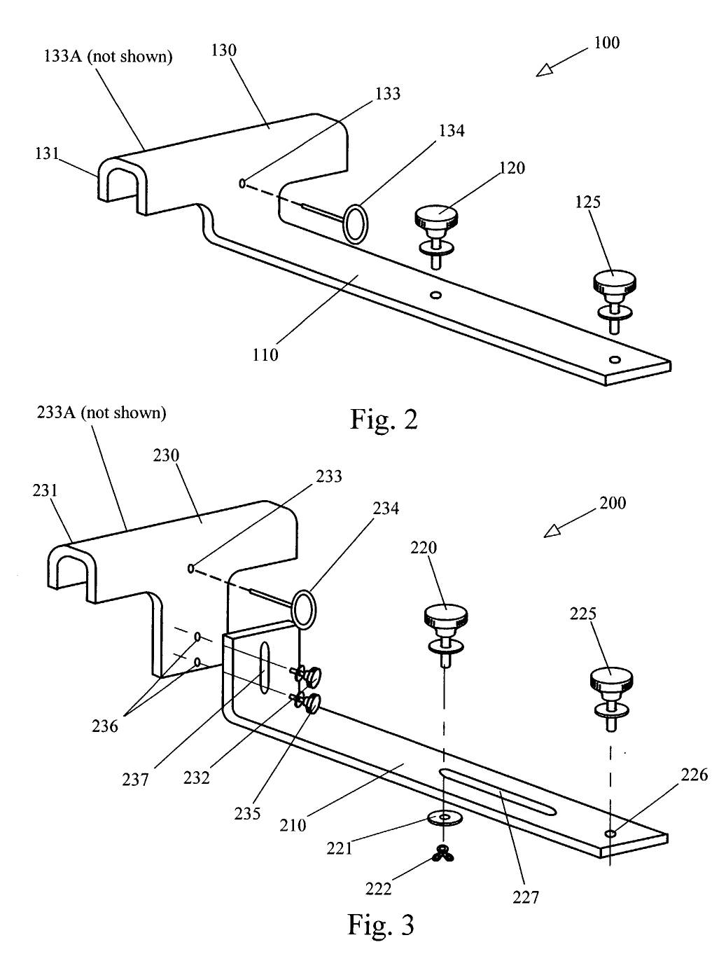

Looking now at FIG. 2, the rigid link member 100 is shown in greater detail. The rigid link 100 is formed by a neck 110, a tongue 130 and a pair of fastening screws 120 and 125. The dimensions of the rigid link member are selected to allow use with a particular pairing of a medical transport vehicle and mobile IV rack. In one exemplary embodiment, the dimensions of rigid link member 100 include a tongue width of 12 inches, a tongue height of 3.75 inches, an axel radius of 0.75 inches, a neck length of 19 inches and a screw separation of eight inches. With these dimensions the rigid link member 100 is suitable for use with a medical transport vehicle with an axel diameter of approximately ½ inch and a mobile IV rack with a base diameter of approximately eighteen inches. As will be understood, other dimensional combinations could be used to accommodate a wide variety of transport vehicle/IV rack pairs. The only requirement of the transport vehicle is that it have unobstructed clearance from the rear axel to the rigid link member.

In use, the tongue 130 is placed over the rear axel of the medical transport vehicle, for example, medical transport vehicle 400 of FIG. 1, and attached via screws 120 and 125 to the base of the mobile IV rack, for example, mobile IV rack 300 of FIG. 1. Rigid link member dimensions are selected such that the height of the transport vehicle axel, the distance between the transport vehicle axel and the base of the IV rack, and the spacing required to attach the rigid member to the IV rack are considered for each pairing of transport vehicle and IV rack.

The tongue 130 is further dimensioned such that tongue face 131 forms a throat sufficiently deep to prevent the rigid link member 100 from ‘jumping’ off the axel of the medical transport vehicle 400. This is necessary since the surface over which the combination of the medical transport vehicle 400, rigid link member 100 and IV rack 300 may include an uneven surface capable of dislodging the rigid link member 100 from the axel of the medical transport vehicle 400. In a preferred embodiment of the present invention, the throat depth is 2.25 inches.

Also shown in FIG. 2 is linchpin 134. Linchpin 134 is inserted through holes 133 and 133A (not shown, but located on the opposite face of the tongue 130) to prevent the rigid link member 100 from disengaging from the transport vehicle axel. As will be recognized, other methods to prevent the disengagement could be employed without departing from the spirit of the invention. For example, a simple bolt and nut arrangement could be used. Alternatively, the dimensions of the throat are such that no retaining hardware may be needed.

Once the rigid link member 100 is in place, the medical transport vehicle 400 and the mobile IV rack 300 may me moved in unison by one person. This improves the efficiency and safety of the transport operation by requiring only one attendant and by providing a low center of gravity pulling force greatly eliminating the risk of toppling. The rigid link member 100 is prevented from slipping off the medical transport vehicle axel by virtue of the attachment to the mobile IV rack. Since the rigid link member is fastened at two points to the mobile IV rack, any vertical movement asserted by the difference in height of the medical transport vehicle axel and the mobile IV rack will be lost as rotation of the member about the axel.

Turning now to FIG. 3, a preferred embodiment 400 of the present invention is shown. In this embodiment the tongue 230 is attached to neck 210 by two screws 232 and 235 which thread into holes 236. Advantageously, the screws 232 and 235 pass through an elongated slot 237, providing a range of vertical adjustment for tongue 230. In this way, the apparatus of the present invention can be made to adapt to a variety of medical transport vehicle axel heights eliminating the need for specially designed IV links as described just above.

Also shown in FIG. 3 are screws 220 and 225. Notice that screw 220 passes through elongated slot 227 and is captured by washer 221 and wing nut 222 while screw 225 threads directly into hole 226. In operation, screw 225 is used to capture the center support member of a mobile IV rack while screw 220 can be adjusted to capture the outer support member of the mobile IV rack. In this way, the apparatus of the present invention can be made to adapt to a variety of mobile IV rack base configurations eliminating the need for specially designed IV links as described just above.

For this exemplary instantiation of the preferred embodiment of the present invention, the dimension of the tongue and neck are generally the same as for the fixed instantiation described above. The elongated slot 237 is 0.25 inches in width by two inches long while the elongated slot 227 is 0.25 inches wide by four inches long. These dimensions have been selected to allow use of the preferred embodiment of the apparatus with a wide range of commercially used mobile IV racks and medical transport vehicles. As with the fixed dimension rigid member described above, the face 231 of the tongue 230 is sufficiently long such that the link member will not jump off the axel of the medical transport vehicle to which it has been coupled. It is understood, however, that other sets of dimensions could be used without departing from the method of the invention, thus the scope of the invention is limited only by the claims.

Linchpin 234 in association with hole 233 and hole 233A (not shown, but located on the opposite face of the tongue 230) operate in a manner similar to that described in FIG. 2 just above. Also as mentioned above, alternative means may be used to capture the rigid link member 200 to the axel of the medical transport vehicle without departing form the spirit of the invention.

Both the embodiment of the present invention shown in FIG. 2 and described above, as well as the preferred embodiment of the present invention shown in FIG. 3 and also discussed above, are fabricated from rolled carbon steel using 0.187 inch stock. However, it will be recognized that other material, for example, medical grade stainless steel, plastic, aluminum or composite fiber, and other fabrication methods, for example extruding, milling, casting or stamping could be used to fabricate the apparatus of the present invention without departing from the spirit of the invention. Thus the scope of the invention is limited only by the claims.

One advantage of the present invention is the elimination of the safety hazard associated with contemporary methods of attaching mobile IV racks to medical transport vehicles. Use of the apparatus of the present invention provides a very low center of gravity pulling force greatly reducing the occurrence of IV rack toppling. In so doing, as well as reducing the safety hazard, the waste of valuable and expensive medical supplies is reduced considerably.

A second advantage of the present invention is the ability of a preferred embodiment of the present invention to accommodate a wide population of contemporary medical transport vehicles and mobile IV racks. This permits medical institutions to purchase a limited number of IV link apparatuses to service a large fleet of medical transport vehicles in a cost effective manner.

A third advantage of the present invention is that only one hospital operator is required to move a patient and the needed mobile IV rack from place to place. This greatly improves the use of hospital staff and again increases the economic savings to the institution.

A fourth advantage of the present invention is that a non-skilled person, for example, a hospital orderly, can quickly and safely install and use the IV link apparatus. More senior or skilled staff may then be left to attend to more urgent and/or skill based needs of the institution. In this way the needs of the patient population are attended to without sacrifice to others.

A fifth advantage of the present invention is that all means of attaching the ambulatory intravenous rack to the medical transport vehicle are contained in the device itself, thus no additional tools are required.

A sixth advantage of the present invention is that when the device is not in use it is stored on the ambulatory intravenous rack. This allows the device to be stored safely and kept in a location where it will not become lost or damaged, yet is readily available when needed.

What is claimed is:

1. A fixed dimension mechanical linkage apparatus for attaching a medical patient transport vehicle to a mobile intravenous carrier rack comprising:
a medical patient transport vehicle;
an mobile intravenous carrier rack, and;
a rigid linkage member, said rigid linkage member engaging a fixed part of said medical patient transport vehicle and a fixed part of said mobile intravenous carrier rack such that movement of said medical patient transport vehicle provides a like movement of said ambulatory intravenous carrier rack.

2. The mechanical linkage apparatus of claim 1 where said fixed mechanical linkage apparatus is attached to a medical transport vehicle in the form of a child's wagon.

3. The mechanical linkage apparatus of claim 1 where said fixed mechanical linkage apparatus is attached to a medical transport vehicle in the form of a wheel chair.

4. The mechanical linkage apparatus of claim 1 where said fixed mechanical linkage apparatus is prevented from disengaging from a medical transport vehicle by means of a linchpin.

5. The fixed mechanical linkage apparatus of claim 1 wherein said fixed mechanical linkage device is formed from a single piece of material by means of a casting process.

6. The fixed mechanical linkage apparatus of claim 1 wherein said fixed mechanical linkage device is formed from a single piece of material by means of a machining process.

7. The fixed mechanical linkage apparatus of claim 1 wherein said fixed mechanical linkage device is formed from a single piece of material by means of an extruding and forming process.

8. A method for mechanically linking a medical transport vehicle to a mobile intravenous carrier rack comprising:
attaching a first end of a fixed mechanical linkage apparatus to the rear axel of a medical transport vehicle, and;
attaching a second end of said fixed mechanical linkage apparatus to a mobile intravenous carrier rack such that a movement of said medical transport vehicle will result in a like movement of said intravenous carrier rack.

9. The method of claim 7 where the medical transport vehicle is a child's wagon.

10. The method of claim 7 where the medical transport vehicle is a wheel chair.

11. An adjustable mechanical linkage apparatus for attaching a medical patient transport vehicle to a mobile intravenous carrier rack comprising:
a medical patient transport vehicle;
an mobile intravenous carrier rack, and;
an adjustable rigid linkage member, further comprised of a horizontally adjustable dimension and a vertically adjustable dimension such that said horizontally adjustable dimension and said vertically adjustable dimension operate in concert to engage a fixed part of a plurality of said medical patient transport vehicles and a fixed part of a plurality of said mobile intravenous carrier racks such that movement of said medical patient transport vehicle provides a like movement of said ambulatory intravenous carrier rack.

12. The mechanical linkage apparatus of claim 10 where said adjustable mechanical linkage apparatus is attached to a medical transport vehicle in the form of a child's wagon.

13. The mechanical linkage apparatus of claim 10 where said adjustable mechanical linkage apparatus is attached to a medical transport vehicle in the form of a wheel chair.

14. The mechanical linkage apparatus of claim 1 where said fixed mechanical linkage apparatus is prevented from disengaging from a medical transport vehicle by means of a linchpin.

15. The adjustable mechanical linkage apparatus of claim 5 wherein said fixed mechanical linkage device is formed from a single piece of material by means of a casting process.

16. The adjustable mechanical linkage apparatus of claim 5 wherein said fixed mechanical linkage device is formed from a single piece of material by means of a machining process.

17. The adjustable mechanical linkage apparatus of claim 5 wherein said fixed mechanical linkage device is formed from a single piece of material by means of an extruding and forming process.

18. A method for mechanically linking a medical transport vehicle to a mobile intravenous carrier rack comprising:
attaching a first end of an adjustable mechanical linkage apparatus to the rear axel of a medical transport vehicle, and;
attaching a second end of said adjustable mechanical linkage apparatus to a mobile intravenous carrier rack such that a movement of said medical transport vehicle will result in a like movement of said intravenous carrier rack.

19. The mechanical linkage apparatus of claim 10 where said adjustable mechanical linkage apparatus is attached to a medical transport vehicle in the form of a child's wagon.

20. The mechanical linkage apparatus of claim 10 where said adjustable mechanical linkage apparatus is attached to a medical transport vehicle in the form of a wheel chair.
